(19) United States
(12) Patent Application Publication
(10) Pub. No.: US 2014/0361749 A1
(43) Pub. Date: Dec. 11, 2014

(54) CONTROL SYSTEM AND CONTROL METHOD FOR CHARGE LEVEL OF BATTERY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHIH-HSIUNG HSIEH, New Taipei (TW); NIU JIN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/200,027

(22) Filed: Mar. 7, 2014

(30) Foreign Application Priority Data
Jun. 6, 2013 (CN) 2013102229330

(51) Int. Cl. H02J 7/00

(52) U.S. Cl. CPC H02J 7/007
USPC 320/136

(57) ABSTRACT

A control system includes a background unit, a control module, a power supply module, and a battery. The background unit includes a procedure subunit, an operation subunit, and a transceiving subunit. The control module includes an information read-write unit and a processing unit. The processing unit includes a detecting subunit, a control subunit, and a switch subunit. The transceiving subunit sends an operating request to the detecting subunit. The detecting subunit detects a dump energy value of the battery and determines whether the dump energy value is less than a predetermined charge level value. When the dump energy value is greater than the predetermined charge level value, the switch subunit is switched on, and the information read-write unit sends powering information to the transceiving subunit, and the operating subunit operates the procedure subunit. The disclosure further offers a control method.

### FIELD

Embodiments of the present disclosure relate to control systems and methods, and particularly to a control system and a control method for charge level of a battery in a computer.

### BACKGROUND

In a computer, such as a laptop, comprises a plurality of procedure subunits. To ensure the plurality of procedure subunits work normally, a power supply module is used to connect to the laptop. Then, if no power supply module is connected to the laptop, the plurality of procedure subunits will work abnormally.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a block diagram of one embodiment of function modules of a control system.

FIG. 2 is a flowchart of one embodiment of a control method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or Assembly. One or more software instructions in the modules can be embedded in firmware. Modules can comprise connected logic units, such as gates and flip-flops, and programmable units, such as programmable gate arrays or processors. The modules described herein can be implemented as either software and/or hardware modules and can be stored in any type of computer-readable medium or computer storage device.

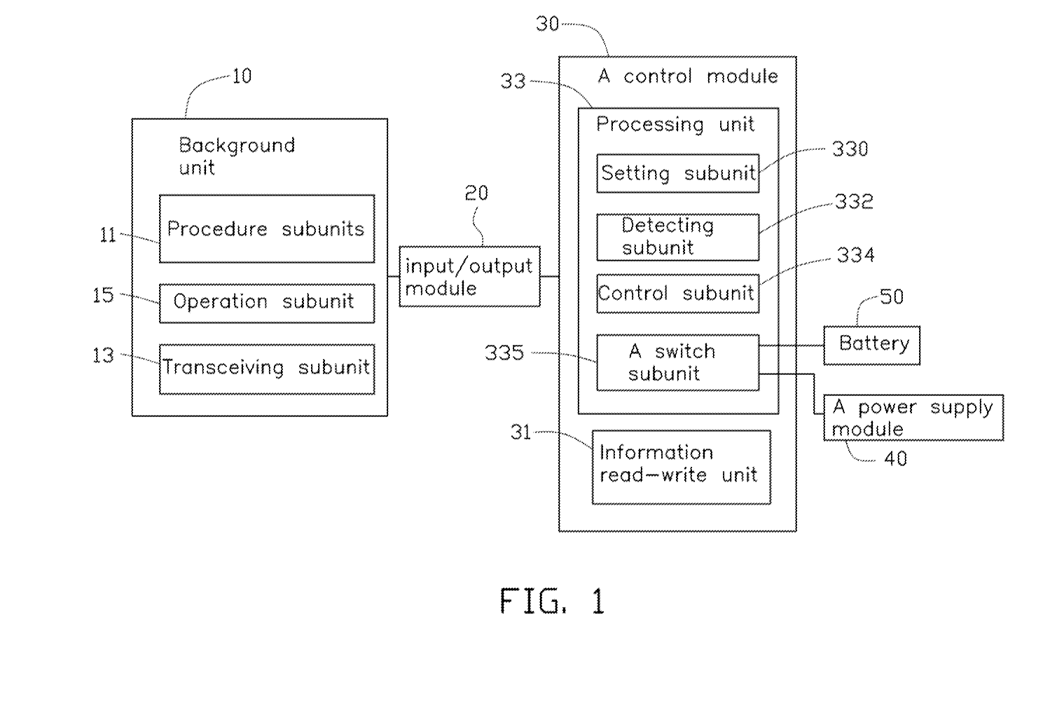

FIG. 1 shows one embodiment of a control system. The control system is used to control a charge level of a battery 50 in a computer (not shown) and comprises a background unit 10, an input/output module 20, a control module 30, and a power supply module 40. In one embodiment, the power supply module 40 is connected to a power supply (not shown).

The background unit 10 comprises a plurality of procedure subunits 11 (only one is shown in FIG. 1), a transceiving subunit 13, and an operation unit 15. The plurality of procedure subunits 11 comprises a plurality of procedures for operating the computer. The transceiving subunit 13 is used to send an operating request to the control module 30 and receive a powering information from the input/output unit 20. The operation subunit 15 is used to operate the plurality of procedure subunits 11 when the transceiving subunit 13 receives the powering information from the input/output unit 20.

The control module 30 comprises an information read-write unit 31 and a processing unit 33 connected to the information read-write unit 31. The processing unit 33 comprises a setting subunit 330, a detecting subunit 332, a control subunit 334, and a switch subunit 335. The setting subunit 330 is used to set a default value of electricity. The detecting subunit 332 is used to receive the operating request from the transceiving subunit 13 and detect a dump energy value. The control subunit 334 is used to compare the dump energy value with the predetermined charge level value, to control the switch subunit 335 for controlling whether the power supply module 40 supplies power for the battery 50. The switch subunit 335 is connected to the battery 50 and the power supply module 40. When the dump energy value is less than the predetermined charge level value, the switch subunit 335 is switched off by the control subunit 334, and the power supply module 40 supplies power for the battery 50. When the dump energy value is greater than the predetermined charge level value, the switch subunit 335 is switched on by the control subunit 334, and the power supply module 40 supplies no power to the battery 50. The information read-write unit 31 is used to detect whether the power supply module 40 supplies power to the battery 50, if yes, the information read-write unit 31 send a first powering information to the input/output module 20, and the input/output module 20 can send the first power information to the transceiving subunit 13. If no, the information read-write unit 40 also sends a second powering information to the power input/output module 20, and the input/output module 20 can send the second power information to the transceiving subunit 13. In one embodiment, the first powering information is same as the second powering information.

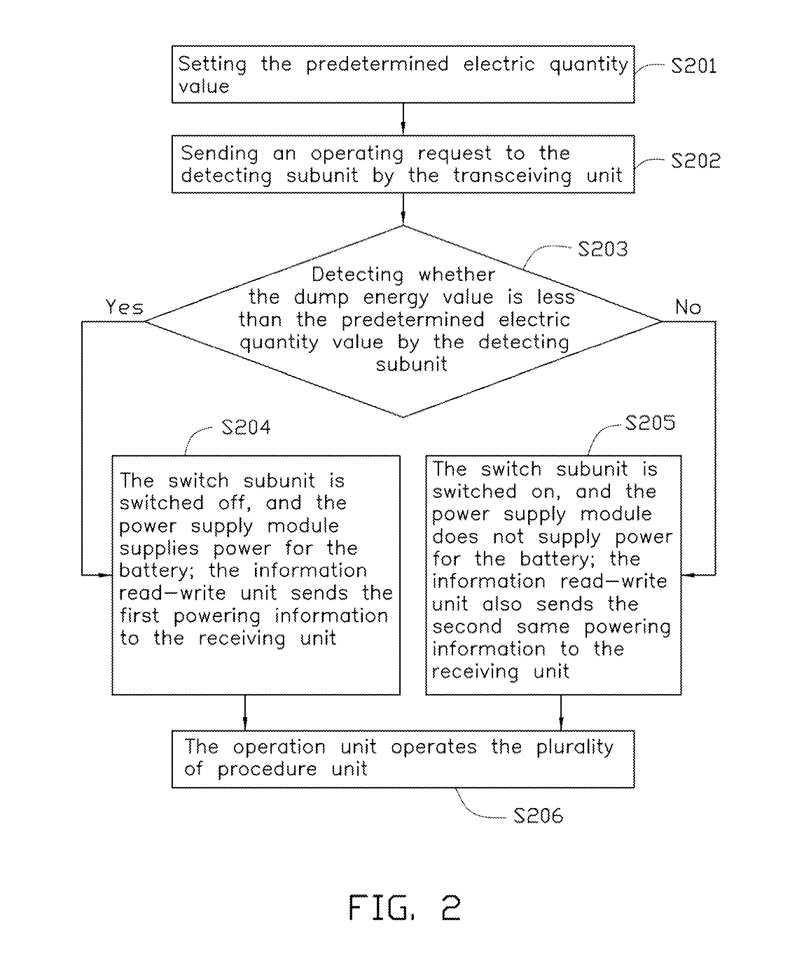

FIG. 2 is a flowchart of one embodiment of a control method using the control system in FIG. 1. Depending on the embodiment, additional steps may be added, others removed, and the ordering of the steps may be changed.

In step S201, the predetermined charge level value is set by the setting subunit 330.

In step S202, when the plurality of procedure subunits 11 needs to be operated, the transceiving subunit 13 sends an operating request to the input/output module 20, and the input/output module 20 sends the operating request to the detecting subunit 332.

In step S203, the detecting subunit 332 detects the dump energy value and determines whether the dump energy value is less than the predetermined charge level value, if yes, goes on step S204; and if no, goes on step S205.

In step S203, the switch subunit 335 is switched off by the control subunit 334, and the power supply module 40 supplies power for the battery 50. At this time, the information read-write unit 31 detects the power supply module 40 supplies power for the battery 50 and send the first powering information to the transceiving subunit 15 by the input/output module 20.

In step S204, the switch subunit 335 is switched on by the control subunit 334, and the power supply module 40 does not supply power for the battery 50. At this time, the information read-write unit 31 detects the power supply module 40 does not supply power for the battery 50 but also sends the second powering information to the transceiving subunit 13 by the input/output module 20.

In step S205, the transceiving subunit 13 receives the first powering information or the second powering information, and the operating subunit 13 operates the plurality of procedure subunit 11.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A control system comprising:
a background unit comprising a procedure subunit, an operation subunit, and a transceiving subunit;
a control module comprising an information read-write unit and a processing unit;
the processing unit comprising a detecting subunit, a control subunit, and a switch subunit;
a power supply module; and
a battery;
wherein the switch subunit is connected to the battery and the power supply module; the transceiving subunit is configured to send an operating request to the detecting subunit, the detecting subunit is configured to detect a dump energy value of the battery and judge whether the dump energy value is less than a predetermined charge level value; when the dump energy value is less than the predetermined charge level value, the switch subunit is switched off by the control subunit, and the information read-write unit sends a first powering information to the transceiving subunit; when the dump energy value is greater than the predetermined charge level value, the switch subunit is switched on by the control subunit, and the information read-write unit sends a second powering information to the transceiving subunit; and the operation subunit is configured to operate the procedure subunit when the transceiving subunit receives the first powering information or the second powering information.

2. The control system of claim 1, wherein the processing unit further comprises a setting subunit, and the setting subunit is configured to set the predetermined charge level value.

3. The control system of claim 1, further comprising an input/output module, wherein the input/output module is connected to the background unit and the control module.

4. A control system comprising:
a background unit comprising a procedure subunit, an operation subunit, and a transceiving subunit;
a control module comprising an information read-write unit and a processing unit;
the processing unit comprising a detecting subunit, a control subunit, and a switch subunit;
a power supply module; and
a battery;
wherein the switch subunit is connected to the battery and the power supply module, and the power supply module is configured to supply power for the battery; and
wherein the transceiving subunit is configured to send an operating request to the detecting subunit, the detecting subunit is configured to detect a dump energy value of the battery and judge whether the dump energy value is less than a predetermined charge level value; when the dump energy value is greater than the predetermined charge level value, the switch subunit is switched on by the control subunit, and the information read-write unit sends a powering information to the transceiving subunit, and the operation subunit is configured to operate the procedure subunit when the transceiving subunit receives the powering information.

5. The control system of claim 4, wherein the processing unit further comprises a setting subunit, and the setting subunit is configured to set the predetermined charge level value.

6. The control system of claim 4, further comprising an input/output module, wherein the input/output module is connected to the background unit and the control module.

7. A control method comprising:
sending an operating request to a detecting subunit by a transceiving subunit;
detecting a dump energy value of a battery and judge whether the dump energy value is less than a predetermined charge level value by the detecting subunit;
switching off a switch subunit by a control subunit when the dump energy value is less than the predetermined charge level value; and sending a first powering information to a transceiving subunit by an information read-write unit; and
switching on the switch subunit by the control subunit when the dump energy value is greater than the predetermined charge level value; and sending a second powering information to the transceiving subunit by the information read-write unit; and
operating a procedure subunit by an operation subunit when the transceiving subunit receives the first powering information or the second powering information.

8. The control method of claim 7, further comprising a step of setting the predetermined charge level value by a setting subunit before the step of sending the operating request to a detecting subunit by the transceiving subunit.

9. The control method of claim 7, further comprising a step of sending the operating request to the detecting subunit by an input/output module before a step of sending the operating request to a detecting subunit by the transceiving subunit, and sending the first and second powering information to the transceiving subunit by the input/output module before a step of operating the procedure subunit by an operation subunit when the transceiving subunit receives the first powering information or the second powering information
